(19) United States
(12) Patent Application Publication
(10) Pub. No.: US 2016/0207404 A1
(43) Pub. Date: Jul. 21, 2016

(54) METHOD FOR DRIVING A MOTOR VEHICLE AND DRIVE SYSTEM FOR A MOTOR VEHICLE

(71) Applicant: FRAUNHOFER-GESELLSCHAFT ZUR FÖRDERUNG DER ANGEWANDTEN FORSCHUNG E.V., München (DE)

(72) Inventors: Tobias MELZ, Darmstadt (DE); Rüdiger HEIM, Darmstadt (DE); Thomas PFEIFFER, Kleinostheim (DE)

(21) Appl. No.: 14/915,436

(22) PCT Filed: Aug. 26, 2014
(86) PCT No.: PCT/EP2014/002329

§ 371 Date: Feb. 29, 2016

(30) Foreign Application Priority Data
Aug. 30, 2013 (DE) 10 2013 014 457.4

(51) Int. Cl. B60L 11/12; B60K 6/28; B60K 6/24; B60L 11/18; B60K 6/46

(52) U.S. Cl. CPC B60L 11/12; B60L 11/1809; B60K 6/46; B60K 6/24; B60K 6/28; B60L 11/1862; B60Y 2200/92; Y10S 903/905; Y10S 903/907

(57) ABSTRACT

The invention relates to a method for driving a motor vehicle and a drive system for a motor vehicle, solely for electro-motorized forward movement. At least one electrical motor is directly or indirectly connected to a drive shaft of the motor vehicle, which is supplied with electrical energy via an energy storage unit, to which energy is supplied with electrical charge current by a generator, driven by a gas engine. The invention is operated during forward movement of the motor vehicle such that an average power demand, which can be allocated to the electrical motor, equals an average power output, which can be allocated to the gas engine, so that a charge state, which can be allocated to the energy storage unit, does not change or changes solely within a charge state within a tolerable range.

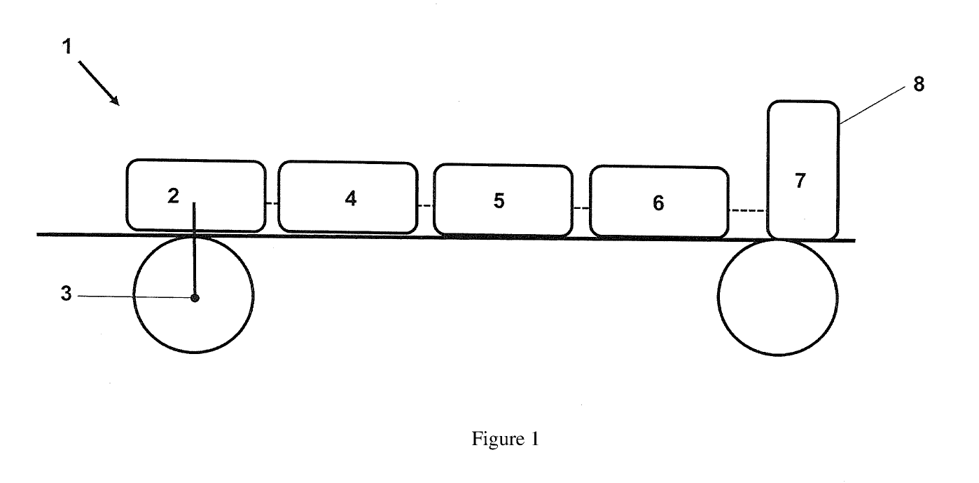

### CROSS REFERENCE TO RELATED APPLICATION

Reference is made to PCT Application Serial No. EP2014/002329 and German Patent Application Serial No. 10 2013 014 457.4 which applications are incorporated herein by reference in its entirety.

### BACKGROUND OF THE INVENTION

1. Field of the Invention

The invention relates to a method of driving a motor vehicle and to a drive system for a motor vehicle, for which the exclusively electrically motorized movement of at least one electrical motor is indirectly or directly connected to a drive shaft of the motor vehicle or at least the drive hub of a wheel of the motor vehicle. The at least one electrical motor is supplied with electrical energy from an energy storage unit with the energy storage unit being supplied with electrical charging current from a generator, which is driven by a gas engine.

2. State of the Art

Electrically driven mobility is of increasing interest in industrialized countries, but actual distribution and use, in particular in electrically powered vehicles, is far less than expected and desired for industrial and political reasons. The reason for this, on the one hand, is the short operating range of electrically driven motor vehicles and, on the other, the up-to-now excessive purchasing cost. The user's high expectations with regard to comfort and range are forcing the technological development to optimize the degree of efficiency of all components involved in the electrical drive chain, which means a similar increase in manufacturing cost. As an example, highly-efficient synchronous electrical motors are used for the direct drive of the wheels, which are supplied with power from lithium ion batteries with particularly high energy density.

In addition, apart from the current known operating range problem, exclusively electrically driven vehicles are also suffering from an operating problem, which is the result of long charging times of the electrical energy storage unit which the vehicle carries, and in the charging-point infrastructure which up to now has not been sufficiently widespread.

In order to avoid or reduce the above-mentioned problems, motor vehicles with hybrid drive are available, in which the drive systems are based on both electrical motors and combustion engines. In particular in cases, where both a combustion engine and at least one electrical motor are provided for directly driving the motor vehicle, gear and clutch units, which are constructionally complex and expensive to manufacture, are required. This fact which, apart from a considerable battery/accumulator weight, is ultimately reflected in the overall weight of the motor vehicle.

On the other hand, hybrid drive concepts for electrically driven motor vehicles are known which have at least one electrical motor connected to a drive shaft with the energy being supplied by a rechargeable battery/accumulator. For the purposes of an electrical energy supply extending beyond the charge capacity of the battery an additional combustion engine is provided, which is a Diesel or gasoline engine, which is connected to a generator for power generation, which is used for charging the battery. A drive concept of this kind is explained in detail in the publication DE 41 21 386 A1. A motor vehicle trailer coupling of a motor vehicle is driven exclusively by an electrical motor in which an energy-supplying trailer, which can be coupled and decoupled is available, which comprises a combustion engine which drives a generator. The electrical energy generated by the generator driven by the combustion engine is used for charging the vehicle battery which allows the operating range which is achievable with the electrical motor vehicle to be increased by exclusively using the total charge stored in the vehicle battery.

A similar drive concept with an energy-supplying trailer for electric cars has been disclosed in the publication DE 94 04 746.4 U1, which uses a gasoline engine provided for driving the generator sitting on the energy-supplying trailer. A further comparable power aggregate on a trailer for electrical motor vehicles is described in DE 37 32 869 A1.

Apart from using Diesel or gasoline engines for driving the generator for power generation, the publication DE 10 2009 045 979 A1 describes use of a gas turbine, which is operated with a mixture of fresh air and a solid, liquid and/or gaseous fuel which enables operation with an optimized efficiency and with fewer emissions compared to conventional Diesel or gasoline engines. Comparable hybrid drive systems with a combination of a gas-turbine and generator as an electrical power source for charging the battery/accumulator unit necessary for driving the electrical motor are disclosed in DE 10 2009 000 530 A1, DE 10 2005 035 313 A1 and US published patent application 2001/0017532 A1.

Apart from Diesel, gasoline and gas-turbine drives for driving a generator for power generation and charging an accumulator/a battery as a power supply for a motor vehicle driven exclusively with by at least one electrical motor, it is also known to use a gas engine driven by liquefied petroleum gas (LPG) or compressed natural gas (CNG) which has lower exhaust gas emissions compared to Diesel and gasoline engines. Such hybrid electrical cars which are combined with a gas engine are described, for example, in the publications DE 10 2008 051 324 A1, DE 10 2010 028 312 A1, DE 195 09 625 A1 and DE 10 2009 027 294 A1.

The publication DE 2007 004 172 A1 discloses an electrical vehicle having an electrical motor supplied with electrical energy by constantly discharging a battery which is carried by the vehicle. A generator driven by a combustion engine which is carried with the vehicle is able to recharge the battery, when the motor vehicle is parked at a standstill. Only in case of an emergency, is an emergency drive mode used which activates an operating device in the vehicle, which allows the vehicle to be driven without a traction battery in a restricted drive mode. In this case, the generator driven by a combustion engine is as an exception to being activated while driving and the electrical power made available via the generator is available directly, by bypassing the traction battery.

WO 2013/000534 A1 describes a serially constructed hybrid motor vehicle comprising an electrical energy storage in which the charge state is increased with a known range extender comprising a combustion engine with a generator. The technical teaching of the publication relates to an economical power control of the combustion engine of a range extender using a generator. The combustion engine is controlled by the number of revolutions which are controlled so that the torque load of the generator is controlled. Control of the torque load of the generator is based on the control of the charging current provided by the generator charging the energy storage carried by the vehicle.

DE 699 27 341 T2 describes a hybrid vehicle in which a combustion engine drives a generator. The generator is connected to the battery and to a second generator for driving the driving wheels. The technical teaching disclosed in this publication is a control logic specifically tailored to individual components of the hybrid vehicle, with which the operation of at least the combustion engine and of the first generator operates in dependence on a plurality of value comparisons between correction and required-actual values.

### SUMMARY OF THE INVENTION

The invention is a method for driving a motor vehicle and respective drive system for a motor vehicle exclusively providing electrically motorized movement of at least one electrical motor which is indirectly or directly connected to a drive shaft of the motor vehicle or at least to a driving hub of a wheel of the motor vehicle. The at least one electrical motor is supplied with electrical energy provided from an energy storage unit which is supplied with a charging current from a generator driven by a gas engine, so that on one hand the problem of operating range is alleviated or solved and on the other hand, low-cost components are utilized. In particular, contrary to the predominant approach of assembling highly optimized individual components in order to achieve an electrical vehicle optimized regarding operating range and efficiency, the requirement is to use tried and tested technologies in such a way to solve the operating range problem in a much more convenient way.

The invention is based on the serial hybrid drive principle in which an exclusively electrically driven motor vehicle uses at least one electrical motor, which is indirectly or directly connected with the drive shaft of the motor vehicle or at least with a drive hub of a wheel of the motor vehicle and is supplied with electrical energy from an energy storage unit with the energy storage unit being charged by a generator driven by a gas engine. The invention, however, rejects reliance on the prevailing development and operating strategy of generic hybrid vehicles having energy storage unit which is not configured for optimized energy density and maximum charge capacity. Rather, the maximum charge capacity of the energy storage unit is dimensioned so that the electrical energy storage is just enough to provide a minimum operating range for a mode of operation based exclusively on an electrical motor as a drive unit without charging the electrical energy storage by a gas-engine-generator unit carried by the vehicle. The limited energy storage capacity of the electrical energy storage is chosen to at least ensure that a minimum operating range of approx. to 50 km is achieved. The controlling factor for determining the operating range is instead the fuel carried along for combustion in the gas engine powering the generator which ensures that the energy storage unit is charged.

The drive according to the invention in the field of electromotive drive technology represents a change in paradigm, clearly against the general development in the field of electrical drive systems/electrical hybrid drive systems, which concern an optimization of efficiency of each individual component. This technical optimization leads to high development cost which results in very high purchasing cost for the consumer as a result of which modern electrical motor driven vehicles are limited circle to those parties having the necessary funds.

The drive made according to the invention is directed away from this technical paradigm which is characterized by a constant shift in technical capacity limits. The invention instead intelligently solves the central range problem existing with current electrical cars on the basis of existing tried and tested technologies. Instead the invention relies on low-cost components, which ultimately will significantly reduce purchasing price which will maximize acceptance of electrical motor driven vehicles.

Accordingly the gas engine is therefore operated during movement of the motor vehicle so that an average power demand, which can be allocated to the electrical motor, corresponds to an average power output, which can be allocated to the gas engine, so that a charge state can be allocated to the energy storage unit which does not change or merely changes the charged state within a tolerance-covered charge state range. This means that the average power withdrawn by the electrical motor from the energy storage unit for movement of the motor vehicle, is indirectly supplied by the gas engine carried by the vehicle, which is preferably continuously operated while the motor vehicle is in operation. The energy storage unit serves merely as an energy buffer which is continuously charged by the gas engine generator unit due to the power generation, while the at least one electrical motor drives the motor vehicle from electrical energy supplies from the energy storage unit. Of course, the electrical charge drawn from the energy storage unit by the at least one electrical motor may mathematically not exactly correspond to the electrical charge supplied by the generator of the energy storage unit. Instead, the charge state of the energy storage unit fluctuates, due to the continuous discharging and charging operations occurring due to motor vehicle operation, within a tolerance range of approx. ±30% about a charge state which can be allocated to the energy storage unit.

In one exemplary embodiment, the energy storage unit may be configured as a suitably dimensioned electrical capacitor having a electrical charge capacity which is small compared to heavy-weight electrical charge accumulators. Due to the capacitor being uninterruptedly charged during motor vehicle operation and the discharging at the same magnitude by the at least one electrical motor, it is not necessary to store a charge quantity within the energy storage unit which exceeds the mean energy demand of the electrical motor. The charge capacity of the energy storage unit should always be chosen such that it is possible for the at least one electrical motor to draw an increased amount of energy at short notice, which may be caused for example by a quick acceleration process such as passing for operation.

In order to compensate for a short-term increased discharge of the energy storage unit due to a short-term increased power demand of the at least one electrical motor, the gas engine, which is preferably operated at a discrete specified number of revolutions per minute (speed) and optimized with regard to efficiency and exhaust gas, must be operated within a tolerance-covered speed range.

Alternatively, it is possible to operate the gas engine at varying discrete speeds, at which the gas engine is likewise operated to be optimized regarding efficiency and emissions of exhaust gases. If operation-dependent driving situations occur, at which an increased prolonged energy consumption occurs on the part of the at least one electrical motor, that is if the motor vehicle has to overcome prolonged climbs, the gas engine is operated at a discrete specified increased speed, due to which the energy storage unit, also adapted to the increased power demand of the at least one electrical motor, which is supplied with an increased charge current.

The operation of the invention for driving a motor vehicle, for an exclusively electrical motorized movement using at least one electrical motor which is indirectly or directly connected with the drive shaft of the motor vehicle, an operating-range-determining energy source, which is not at the maximum charge capacity of the energy storage unit is carried with the vehicle. Instead, the capacity of the storage unit is determined by the quantity of the fuel carried along with the vehicle, which drives the gas engine and thus the generator connected therewith to generate electrical power. In a preferred embodiment, the charge capacity of the energy storage unit as well as the gas engine and the amount of fuel carried along for operation of the gas engine are chosen and adjusted in relation to one another in such a way that the electrical energy share obtained by exclusive combustion of the fuel within the gas engine and the driving of the generator connected therewith, is at least 60%, preferably at least 70% up to a maximum of 90% of the maximum operating range achievable with the motor vehicle. That means that the electrical energy shared storage in a fully charged energy storage unit contributes between a mere 10% up and a maximum of 40% to the maximum operating range of the drive system configured according to the invention. Moreover an operation would be feasible, where the energy storage unit is completely discharged, which is the case when the maximum operating range of the motor vehicle has been reached. If in this case it would be possible to only fill the fuel tank, that is the gas tank, but not the electrical energy storage unit, the maximum operating range of the motor vehicle in this case would depend exclusively on the technically usable energy content of the fuel quantity. That is the share of the fuel in the maximum achievable range would be 100%.

Even if the operational concept of the invention deviates from tradition, the electrical energy consumed exclusively is in terms of a zero-emission vehicle. The driving of a vehicle according to the invention avoids weight-dependent and charge-capacity-dependent range problems and in addition permits a low-cost realization of an electrical motor vehicles using conventional technologies such. That is conventional and low-cost electrical charge accumulators, preferably based on a nickel metal hybrid, an alkali-manganese, a zinc chloride or a zinc carbon battery are used.

Moreover there is already a comprehensive and widespread infrastructure with regard to fuel for gas engines, preferably in the form of liquid petroleum gas (LPG) or compressed natural gas (CNG).

Apart from the possible charging the energy storage during movement of the motor vehicle via the described gas engine generator operation as well as due to energy recovery during braking operations, where the reverse electrical motor generator principle is used, it is also possible, from a respective fuel reserve, to charge the motor vehicle when at standstill by gas engine operation and the generator connected therewith. Thus the motor vehicle can be operated independently even for possible electrical charge stations, in particular in areas, in which there is no infrastructure for the charging of purely electrically driven vehicles or such infrastructure does not exist to a sufficient extent.

Realization of the drive system configured according to the invention for a motor vehicle with at least one electrical motor which is indirectly or directly connected with a drive shaft of the motor vehicle, with an electrical energy storage unit which for electrical energy supply is achieved. The system which is electrically connected to the electrical motor, as well as a gas engine in operative connection with a generator for electrical power generation, with the generator being electrically connected to the electrical energy storage unit for the supply of charging current, is achieved by using a monovalent gas engine which is preferably driven with LPG or CNG fuel, with the amount of fuel carried by the vehicle having an energy content substantially determined by the maximum operating range of the motor vehicle. The electrical energy storage unit on the other hand comprises a charge capacity which does not determine the operating range for the motor vehicle. Or a quasi-monovalent gas engine may be used, which apart from purely burning LPG or CNG can if required also be operated with gasoline.

The use of a gas engine in contrast to conventional gasoline engines permits significantly lower emission values especially immediately upon a cold start, because gas engines are more efficient compared to conventional combustion engines due to the higher compression. Furthermore it is possible to increase efficiency of gas engines by operating the gas engine at an optimal operating point, which is at a specified speed. Moreover gas engines, as compared to conventional gasoline or Diesel fuel driven combustion engines, have the advantage that refilling is possible in principle by connection to a gas connection in buildings connected to gas.

### BRIEF DESCRIPTION OF THE DRAWINGS

The invention will now be explained without restriction of the general inventive concept by way of an exemplary embodiment with reference to the single drawing, which schematically depicts all components for an electrical motor-driven vehicle according to the invention.

### DETAILED DESCRIPTION OF THE INVENTION

The FIGURE shows the driving system according to the invention based on a purely electrical motor driven motor vehicle 1. At least one electrical motor 2 is required for driving the vehicle which drives the drive shaft 3, which is connected to an electrical energy store 4, which is electrically charged by a generator 5 driven by a monovalent or bivalent gas engine 6. The fuel 7 for operating the gas engine 6 is stored in a suitable fuel tank 8 carried along with the motor vehicle 1. The mode of operation according to the invention is based on an approximation of an average power demand of the electrical motor 2 and the average power output of the gas engine 6. In this way it can be ensured that the charge state of the energy storage unit 4 carried by the vehicle does not or it does not essentially change while the motor vehicle 1 is travelling.

Only with this mode of operation is it possible to configure the electrical energy storage unit 4, to not have an energy source determining the operating range as is the case with all previously known solutions. Instead the energy storage unit 4 functions as a buffer unit or intermediate storage unit for the electrical energy generated by the gas engine 6 and the downstream generator 5. In a theoretical extreme case, the electrical energy storage unit 4 could be configured as a mere capacitor with a charge capacity limited to depend on the system and which merely serves to pass the electrical energy stored intermediately in the capacitor onto the electrical motor 2. Typically the energy storage unit 4 may be configured as a nickel metal hybrid, an alkali-manganese, a zinc chloride or a zinc carbon battery.

Due to the completely different mode of operation of the energy storage unit 4, when compared to optimized charge-capacity modern battery systems, there are no stringent requirements to be met regarding charging capacity characteristic. This allows the driving operation according to the invention to use conventional, in particular low-cost energy storage units. Moreover, the method according to the invention permits the operation of a gas engine 6 for at least one optimized working point so that despite a conventional driving technology highest economic requirements as well as ecological requirements are met. The maximum operating range of the electric-motor-driven motor vehicle 1 achievable with the driving operation according to the invention is determined essentially by the fuel 7 carried along, for example liquid petroleum gas (LPG) or compressed natural gas (CNG) for operating the gas engine 6. In this way operating ranges are achieved which correspond to the operating ranges of conventionally driven motor vehicles 1, so that there are no “range” issues for the final customer as is the case with electrical cars of the latest design.

### LIST OF REFERENCE SYMBOLS

1 motor vehicle
2 electric motor
3 drive hub
4 energy storage unit
5 generator
6 gas engine
7 fuel
8 fuel tank

1-12. (canceled)

13. A method for driving a motor vehicle for electrical-motorized movement of a vehicle including at least one-electrical motor coupled to a drive shaft or drive hub of the motor vehicle which is supplied from an electrical energy storage unit which stores electrical charge supplied by current from a generator driven by a gas engine, comprising:
operating the motor vehicle during movement of the motor vehicle so that an average power demand allocated to the electrical motor during the operation corresponds to an average power output allocated to the gas engine so that a charge state allocated to the energy storage is within a charge state range of operation of the electrical energy storage unit.

14. The method according to claim 13, wherein the gas engine is operated at a constant speed or at a speed within a specified speed range, at which a speed operating point of the gas engine is optimized regarding efficiency and/or emissions.

15. The method according to claim 13, wherein the gas engine is operated at operating points within a speed range so that when a power demand of the electrical motor exceeds the average power demand, speed of the gas engine is increased in a step-wise, in a switchable manner or in a covered speed range, and the gas engine in operation is optimized regarding at least one of efficiency and emissions.

16. The method according to claim 14, wherein the gas engine starting from at least one speed operating point, is operated with a time limited, variable-speed booster function, providing a power demand of the electrical motor which exceeds the average power demand.

17. The method according to claim 15, wherein the gas engine starting from at least one speed operating point, is operated with a time limited, variable-speed booster function, providing a power demand of the electrical motor which exceeds the average power demand.

18. The method according to claim 14, wherein the gas engine is operated with liquid petroleum gas or compressed natural gas.

19. The method according to claim 15, wherein the gas engine is operated with liquid petroleum gas or compressed natural gas.

20. The method according to claim 16, wherein the gas engine is operated with liquid petroleum gas or compressed natural gas.

21. The method according to claim 17, wherein the gas engine is operated with liquid petroleum gas or compressed natural gas.

22. The method according to claim 14, wherein a maximum charge capacity is allocated to the energy storage unit and a maximum quantity of fuel carried along in the motor vehicle is chosen such that a maximum operating range achievable with the motor vehicle for a part of the operating range, is achieved by burning the fuel exclusively within the gas engine and is converted by the generator into electrical energy for driving the motor vehicle with the share being between 60% and 90%.

23. The method according to claim 15, wherein a maximum charge capacity is allocated to the energy storage unit and a maximum quantity of fuel carried along in the motor vehicle is chosen such that a maximum operating range achievable with the motor vehicle for a part of the operating range, is achieved by burning the fuel exclusively within the gas engine and converted by the generator into electrical energy for driving the motor vehicle with the share being between 60% and 90%.

24. The method according to claim 16, wherein a maximum charge capacity is allocated to the energy storage unit and a maximum quantity of fuel carried along in the motor vehicle is chosen such that a maximum operating range achievable with the motor vehicle for a part of the operating range, is achieved by burning the fuel exclusively within the gas engine and is converted by the generator into electrical energy for driving the motor vehicle with the share being between 60% and 90%.

25. The method according to claim 18, wherein a maximum charge capacity is allocated to the energy storage unit and a maximum quantity of fuel carried along in the motor vehicle is chosen such that a maximum operating range achievable with the motor vehicle for a part of the operating range, is achieved by burning the fuel exclusively within the gas engine and is converted by the generator into electrical energy for driving the motor vehicle with the share being between 60% and 90%.

26. The method according to claim 14, wherein a tolerated charge state range is a maximum ±30% of a charge state allocated to the energy storage unit.

27. The method according to claim 15, wherein a tolerated charge state range is a maximum ±30% of a charge state allocated to the energy storage unit.

28. The method according to claim 18, wherein a tolerated charge state range is a maximum ±30% of a charge state allocated to the energy storage unit.

29. The method according to claim 22, wherein a tolerated charge state range is a maximum ±30% of a charge state allocated to the energy storage unit.

30. The method according to claim 14, wherein the electrical energy storage unit is charged during standstill of the motor vehicle by operating the gas engine.

31. The method according to claim 15, wherein the electrical energy storage unit is charged during standstill of the motor vehicle by operating the gas engine.

32. The method according to claim 16, wherein the electrical energy storage unit is charged during standstill of the motor vehicle by operating the gas engine.

33. The method according to claim 18, wherein the electrical energy storage unit is charged during standstill of the motor vehicle by operating the gas engine.

34. The method according to claim 22, wherein the electrical energy storage unit is charged during standstill of the motor vehicle by operating the gas engine.

35. The method according to claim 26, wherein the electrical energy storage unit is charged during standstill of the motor vehicle by operating the gas engine.

36. A drive system for a motor vehicle comprising at least one electrical motor coupled to a drive shaft or drive hub of the motor vehicle, an electrical energy storage unit electrically connected with the electric motor for supplying electrical energy, and a gas engine for powering electrical power generation operatively connected with a generator, which is electrically connected to the electrical energy storage unit for supplying charging current; and wherein the gas engine is a mono- or bivalent gas engine, and the electrical energy storage unit has a charge capacity which does not determine a range of the motor vehicle.

37. The drive system according to claim 36, wherein a maximum charge capacity of the energy storage unit and a quantity of fuel carried by the motor vehicle are chosen so that a maximum operating range achievable with the motor vehicle for a part of the operating range, can be achieved by burning the fuel exclusively within the gas engine and conversion by the generator into electrical energy for driving the motor vehicle, and the share is between 60% and 90%.

38. The drive system according to claim 36, wherein the electrical energy storage unit is an electrical charge accumulator, comprising one of a nickel metal hybrid, alkali-manganese, zinc chloride or zinc carbon battery.

39. The drive system according to claim 37, wherein the electrical energy storage unit is an electrical charge accumulator, comprising one of a nickel metal hybrid, alkali-manganese, zinc chloride or zinc carbon battery.

40. The drive system according to claim 36, wherein the gas engine comprises a fuel tank for liquid petroleum gas or compressed natural gas.

41. The drive system according to claim 37, wherein the gas engine comprises a fuel tank for liquid petroleum gas or compressed natural gas.

42. The drive system according to claim 38, wherein the gas engine comprises a fuel tank for liquid petroleum gas or compressed natural gas.
